(19) United States
(12) Patent Application Publication
(10) Pub. No.: US 2012/0111430 A1
(43) Pub. Date: May 10, 2012

(54) INTEGRATED SELF-CONTAINED ZONING PLENUM

(76) Inventors: JOHN B. EDWARDS, ONTARIO, CA (US); JOAQUIN D. CONTRERAS, SAN BERNARDINO, CA (US)

(21) Appl. No.: 13/288,882

(22) Filed: Nov. 3, 2011

Related U.S. Application Data
(60) Provisional application No. 61/410,300, filed on Nov. 4, 2010.

(51) Int. Cl. F15D 1/00

(52) U.S. Cl. 137/561 R

(57) ABSTRACT

The device overcomes the inability of a single HVAC system, when the entire building (or upon each HVAC system which is serving the building) to create optimal occupant comfort, realize potential energy savings, adjust for times of occupancy, and overcome internally and externally imposed changes to comfort when controlled by a single temperature control device. The invention allows the occupant(s) to employ multiple temperature control devices, which results in meeting the requirements for occupant comfort, energy savings, and adjust for times of occupancy.

### CROSS-REFERENCE TO RELATED APPLICATIONS

This application claims the benefit of priority of pending U.S. Utility Provisional Patent Application No. 61/410,300, filed 4 Nov. 2010, the entire disclosure of which is expressly incorporated by reference in its entirety herein.

### BACKGROUND OF THE INVENTION

1. Field of the Invention

The present invention relates to an integrated self-contained zoning plenum.

2. Description of Related Art

Conventional air conditioning systems are well known and have been in use for a number of years. Most conventional systems suffer from obvious disadvantages in that they cannot compensate for varying temperatures or varying loads in rooms outside of the thermostat location.

Accordingly, in light of the current state of the art and the drawbacks to current air conditioning systems mentioned above, a need exists for multiple points of control for temperature occupancy, load, and time of use that would adequately control the areas not directly influence by the thermostat.

### BRIEF SUMMARY OF THE INVENTION

The device overcomes the inability of a single HVAC system, when the entire building (or upon each HVAC system which is serving the building) to create optimal occupant comfort, realize potential energy savings, adjust for times of occupancy, and overcome internally and externally imposed changes to comfort when controlled by a single temperature control device. The invention allows the occupant(s) to employ multiple temperature control devices, which results in meeting the requirements for occupant comfort, energy savings, and adjust for times of occupancy.

The present invention further provides a device, comprising:
an air plenum with a diversion damper;
motor for moving and positioning the diversion damper along a reciprocating path;
a control board for controlling motor rotation.

Such stated advantages of the invention are only examples and should not be construed as limiting the present invention. These and other features, aspects, and advantages of the invention will be apparent to those skilled in the art from the following detailed description of preferred non-limiting exemplary embodiments, taken together with the drawings and the claims that follow.

### BRIEF DESCRIPTION OF THE DRAWINGS

It is to be understood that the drawings are to be used for the purposes of exemplary illustration only and not as a definition of the limits of the invention. Throughout the disclosure, the word “exemplary” is used exclusively to mean “serving as an example, instance, or illustration.” Any embodiment described as “exemplary” is not necessarily to be construed as preferred or advantageous over other embodiments.

Referring to the drawings in which like reference character(s) present corresponding part(s) throughout:

FIG. 1 is a non-limiting exemplary rear or back view illustration of division damper in accordance with the present invention;

FIG. 2 is a non-limiting exemplary side-view illustration of diversion damper in various positions along a reciprocating path in accordance with the present invention;

FIGS. 3A and 3B are a non-limiting exemplary front-views illustrations of a motor and control board for the diversion damper in accordance with the present invention;

FIG. 4 is a non-limiting exemplary illustration of the motor and control board in accordance with the present invention;

FIG. 5 is a non-limiting exemplary illustration of the diversion damper with motor assembly removed, in accordance with the present invention;

FIG. 6 is a non-limiting exemplary illustration of a side-view of the motor and control board assembly in accordance with the present invention; and

FIG. 7 is a non-limiting exemplary illustration of a top-view of the motor and control board assembly shown in FIG. 6 in accordance with the present invention.

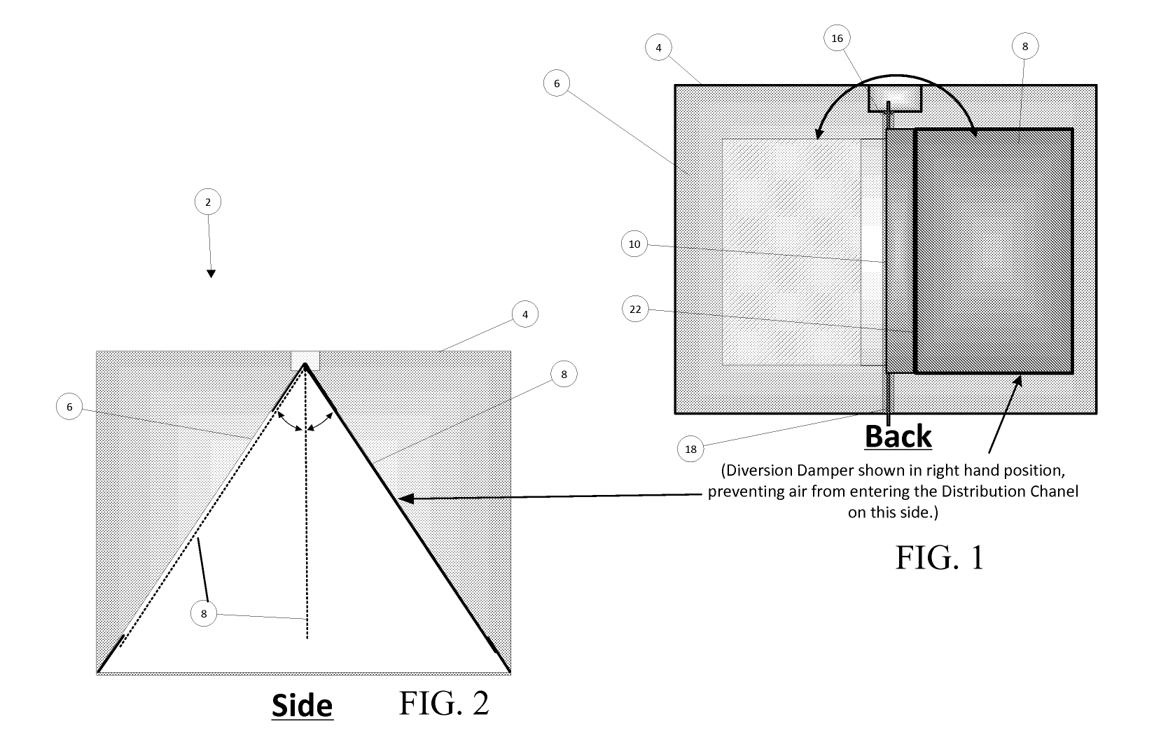

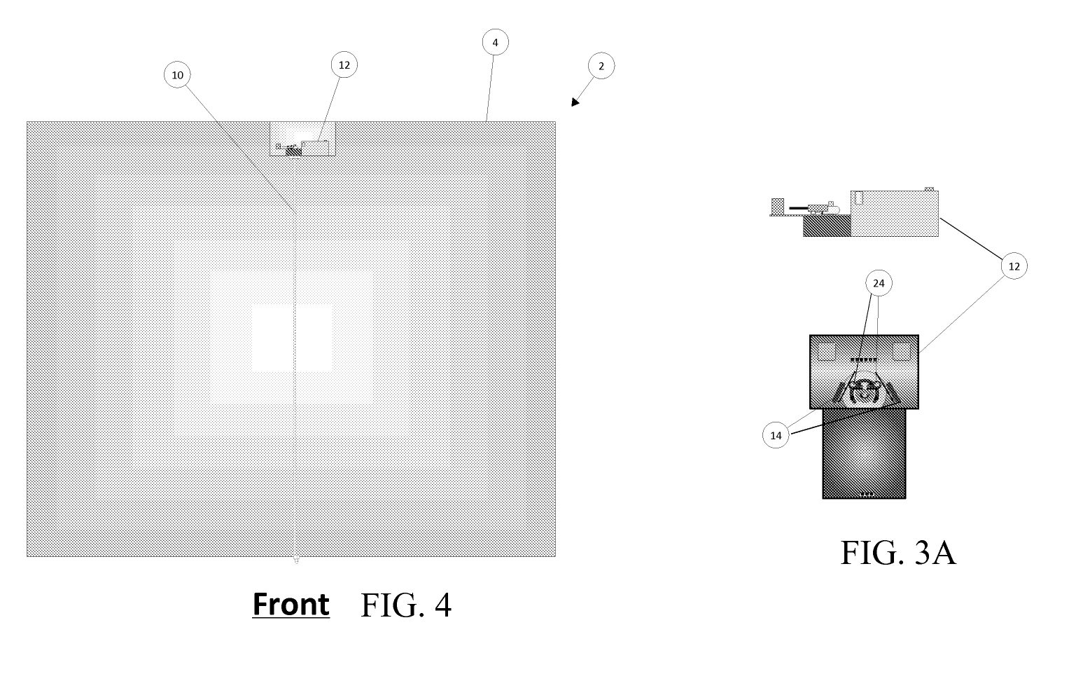

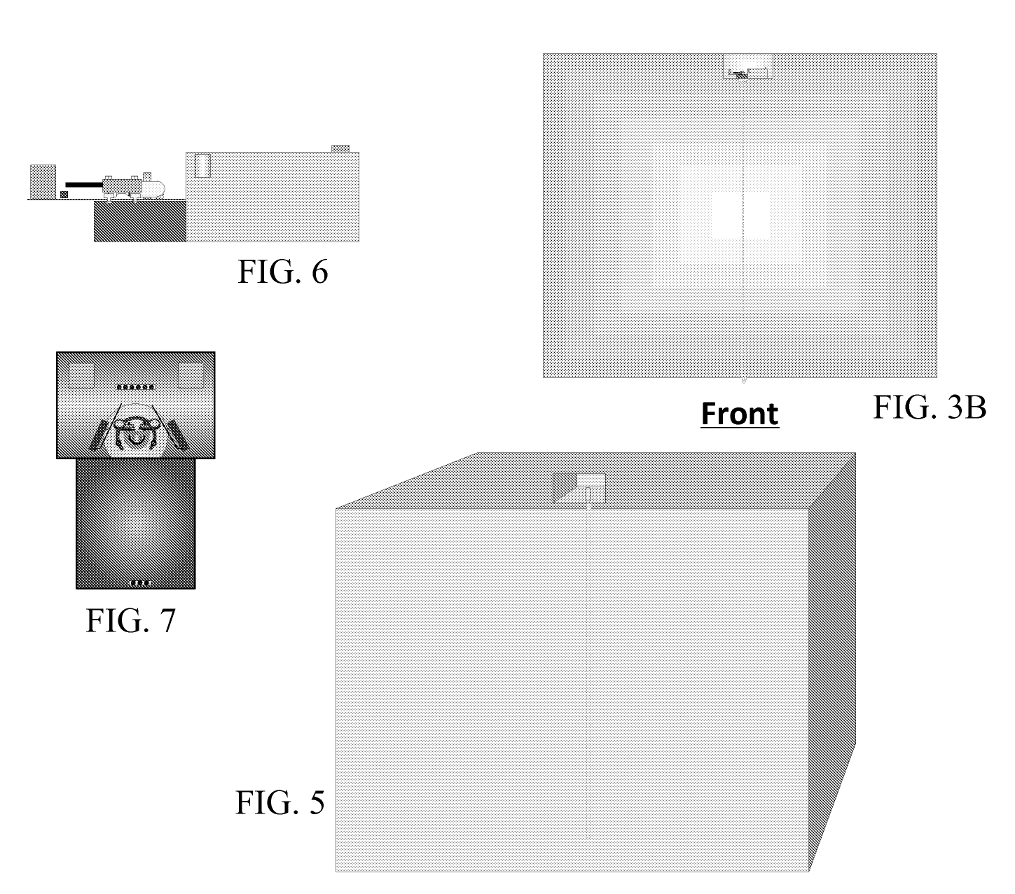

### DETAILED DESCRIPTION OF THE INVENTION

The detailed description set forth below in connection with the appended drawings is intended as a description of presently preferred embodiments of the invention and is not intended to represent the only forms in which the present invention may be constructed and or utilized.

The Device (2) is configured and designed to overcome the inability of a singularly temperature controlled HVAC system to create comfort, energy saving, and time of occupancy “zones” in a building. It may have the ability to control two or more “zones” from a single HVAC system. The device is installed in a vertical, horizontal, inverted, or cross-mounted position and can be configured to deliver conditioned air to two or more separate areas served by a single HVAC unit, meeting any installation requirement. As individual temperature control devices request heating, cooling, or air circulation, based on requirements for Comfort, Energy savings, or Occupancy. Any or all components of this device may be comprised of formed sheet metal or another substance constructed of a natural, plastic, or other synthetic material.

Conditioned Air Distribution Plenum (4) is designed and configured to allow for various sizes of duct to be connected to meet individual installation applications. The Conditioned Air Distribution Plenum (4) connects the distribution duct system to the HVAC system, and may be constructed of metallic, plastic, or synthetic materials.

Distribution Pathway Assembly (6) allows conditioned air to pass into the Conditioned Air Distribution Plenum (4) as requested by the individual temperature control devices and allows the Diversion Damper (s) to either direct conditioned air into the zone or seals any zone not requesting the current mode of conditioned air by closing the Distribution Pathway Assembly(6) to that zone, and may be constructed of metallic, plastic, or synthetic materials.

Diversion Damper (s) (8) is designed and configured to either allow or prevent conditioned air to pass through the Distribution Pathway Assembly (6) based on the request(s) from the individual temperature control devices, and may be constructed of a natural, plastic, or other synthetic material.

Diversion Damper Control Shaft (10) is designed and configured to control the position of the Diversion Damper (s) (8) and may be constructed of a natural, plastic, or other synthetic material.

The Actuator Control Assembly (12) drives the Diversion Damper (6) into position from voltage signals received from an external Zoning Control Board (not part of this device) which may be incorporated as an integral component of the Device, commanded by individual temperature control devices.

The Diversion Damper Positioning Control Switches (14) are used to isolate and interconnect the run open and run closed motor windings to allow one motor to drive the Diversion Damper (s) (8) from the required position to allow for; zone (s) to open and zone(s) to close.

The Front Bearing (16) is a sleeve-type bearing that allows the Diversion Damper Control Shaft (10) to be suspended in position while allowing free centerline rotation as required, which may be incorporated into the Device (2) in the case of the Device being constructed of a natural, plastic, or other synthetic material.

The Rear Bearing (18) is a shaft-end mounted, sleeve-type bearing that allows the Diversion Damper Control Shaft (10) to be suspended in position while allowing free centerline rotation as required, which may be incorporated into the Device (2) in the case of the Device being constructed of a natural, plastic, or other synthetic material.

The Distribution Pathway Assembly Seal (20) is designed and configured to be mounted on the perimeter of the Diversion Damper (8) to eliminate air leakage through the into a closed zone.

The Diversion Damper Seal (20) is designed and configured to be mounted on the top of the Diversion Damper (8) to prevent air from passing into an adjacent chamber of the distribution pathway.

The Diversion Damper Position Control Trip Cams (22) allow the Diversion Damper Positioning Control Switches (14) to isolate and interconnect the run open and run closed motor windings to allow one motor to drive the Diversion Damper (8) from the required position to allow for; zone (s) open to zone(s) closed, and may be constructed of metallic, plastic, natural or synthetic materials.

The Diversion Damper Control Shaft (10) preferably positioned in the Conditioned Air Distribution Plenum (4) by the Front Bearing (16) and the Rear Bearing (18) and connected to the Conditioned Air Distribution Plenum (4) via the U-Clamp attached to the Actuator Control Assembly (12). Any connections described in this application may include any known connectors, including screws, bolts, rivets, Stitch weld, spot, weld, button lock, adhesives, etc. The Front Bearing (16) and the Rear Bearing (18) are preferably connected perpendicularly to the Conditioned Air Distribution Plenum (4) although they may instead be attached to the Distribution Pathway Assembly (6) by the means stated above.

The Diversion Damper Control Shaft (10) is preferably connected to the Diversion Damper (8) by rivets extending both the Damper Control Shaft (10) and the Diversion Damper (8), by the means stated above. The connection between the Damper Control Shaft (10) and the Diversion Damper (8) via a roll-formed channel at the top of the Diversion Damper (8) and may be fixed and solid, or may be configured to accept multiple dampers. For example, the connection could comprise integral counter-rotating shafts or individual, dedicated to accommodate additional Actuator Control Assembly (s) (12) (not shown) that allow the Diversion Damper Control Shaft (s) (10) to rotate independently, or may be comprised of a resilient material that bends with stress, such as a plastic or synthetic material. The Diversion Damper (s) (8) and Actuator Control Assembly (s) (12) may be installed in multiple locations on the Conditioned Air Distribution Plenum (4) to accommodate a requirement for more than two zones of control and may be constructed of a natural, plastic, or other synthetic material.

The Conditioned Air Distribution Plenum (4) is preferably connected to the Distribution Pathway Assembly (6) by the means stated above, and may be constructed of a natural, plastic, or other synthetic material.

The Actuator Control Assembly (s) (12) is preferably connected to the upper surface of the Conditioned Air Distribution Plenum (4) by screws and extending into the Conditioned Air Distribution Plenum (4) by the means stated above.

The Distribution Pathway Assembly Seal (20) is designed to be mounted on the perimeter of the openings in the Distribution Pathway Assembly (6) and is preferably connected by the use of both a heat resistant adhesive and screws, but may also be connected by the means stated above. Further, the Distribution Pathway Assembly Seal (20) may be mounted in or on the Distribution Pathway Assembly (6) in an edge mount (not shown) or inset from the opposite side (not shown).

The invention provides a means to deliver conditioned air to the space or building by positioning the Diversion Damper (s) (8) to open or close against the Distribution Pathway Assembly (6) based on input from the temperature control devices which feed their individual requirements to the Zone Control Panel (NIC). Further, the Zone Control Panel (not shown) may be incorporated as an integral component in the invention.

As the Diversion Damper (s) (8) is driven against the Distribution Pathway Assembly (6) and the Distribution Pathway Assembly Seal (20) air is withheld from the zone(s) not requiring conditioned air and conditioned air is allowed to flow to the areas that require conditioned air. If all zones require conditioned air, the Diversion Damper (s) (8) are positioned such that it (they) allow conditioned air to flow into all zones. Additionally, when the last requirement for conditioned air is satisfied, the Diversion Damper (s) (8) are moved to the center position to await the next requirement for conditioned air from the various temperature control devices.

The Conditioned Air Distribution Plenum (4), Distribution Pathway Assembly (6), Distribution Pathway Assembly Seal (20), Diversion Damper (s) (8), Diversion Damper Seal (20) Front Bearing (16), Rear Bearing (18), Diversion Damper Control Shaft (s) (10), Actuator Control Assembly (s) (12), Diversion Damper Position Control Trip Cams (22), and Diversion Damper Positioning Control Switches (14) are necessary elements of this invention. The optional elements all provide additional features and benefits as previously described.

For example, the addition of multiple Diversion Damper (s) (S) Diversion Damper Control Shaft (s) (10), Actuator Control Assembly (s) (12), Diversion Damper Position Control Trip Cams (22), and Diversion Damper Positioning Control Switches (14) provide for additional zones of control.

The invention may include additional beneficial features. As discussed, the Invention may be installed on split horizontal, vertical, down-flow, cross-flow, high velocity, heat pump, natural gas, electric heat, and packaged HVAC equipment.

To make this invention, one could first provide the elements; Conditioned Air Distribution Plenum (4), Distribution Pathway Assembly (6), Diversion Damper (s), Diversion Damper Control Shaft (s) (10), which may be constructed of metallic, plastic, or synthetic materials and either punched and bent to the required form, injection molded, or formed from another natural or synthetic material and assembled utilizing by the means stated above, (S)Distribution Pathway Assembly Seal (20), Damper Seal (20) Front Bearing (16), Rear Bearing (is) which may be incorporated into the device as an integral component as stated above, Actuator Control Assembly (s) (12), Diversion Damper Position Control Trip Cams (22), and Diversion Damper Positioning Control Switches (14). Then, these elements could be connected using screws and/or adhesives to produce the invention as shown in the drawing.

A person would use the invention in the following way. First, she would provide the device (2), attaching it to the outlet side of a forced air furnace, heat pump, air conditioning coil, or the supply connection on a packaged HVAC system. She may ensure that the Device is both rigidly and securely mounted in the above applications, using screws, rivets, adhesives, and sealants to assure secure mounting and eliminate any air leakage. Next, she would connect the ductwork serving the individual areas of the space or building to be controlled. Then, she would make the appropriate wire connections from the device to the Zoning Control Panel (not shown, which may be included as an integral component of the device), then wire the individual temperature control devices (NIC/not shown) in the space or building to the Zoning Control Panel per the manufactures recommendations.

In one embodiment, the Device could be applied as a stand-alone device connected to the supply duct from the HVAC unit to the individual areas of the space or building to be controlled individually. For example, if she was limited in available space to mount the Device directly to the HVAC system, the Device would then be remotely mounted to serve the same purpose.

The currently available solution is to install comfort control devices (zone dampers) in the duct system, which can be impossible due to access or available space, or flush-mount pre-manufactured dampers in the plenum, which is cost prohibitive and offers no installed cost savings.

Our invention removes the barriers to occupant comfort, energy savings, and adjusts for times of occupancy which are inherent in every singularly temperature controlled HVAC system. Our invention additionally overcomes the inability of conventional comfort control devices to create these individual comfort areas when there is limited or no space within the structure to allow for their conventionally applied inclusion.

HAVC systems of various configuration, evaporative coolers, clean room air delivery systems, compressed air or gas delivery systems, industrial, automotive, marine, aeronautical air delivery systems, multi-volume/flow combustion or other air delivery systems in extreme climates, high or low altitude air delivery systems; HEPA, electronic, media, filtration, induced or draft air by-pass applications, air or process humidification and dehumidification applications, high velocity HVAC systems, fresh air ventilation systems.

Although the invention has been described in considerable detail in language specific to structural features and or method acts, it is to be understood that the invention defined in the appended claims is not necessarily limited to the specific features or acts described. Rather, the specific features and acts are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. Such variations and alternate embodiments are contemplated, and can be made without departing from the spirit and scope of the invention.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, oblique, proximal, distal, parallel, perpendicular, transverse, longitudinal, etc. have been used for convenience purposes only and are not intended to imply any particular fixed direction or orientation. Instead, they are used to reflect relative locations and/or directions/orientations between various portions of an object.

In addition, reference to “first,” “second,” “third,” and etc. members throughout the disclosure (and in particular, claims) is not used to show a serial or numerical limitation but instead is used to distinguish or identify the various members of the group.

In addition, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of,” “act of,” “operation of,” or “operational act of” in the claims herein is not intended to invoke the provisions of 35 U.S.C. 112, Paragraph 6.

What is claimed is:

1. A device, comprising:
an air plenum with a diversion damper;
motor for moving and positioning the diversion damper along a reciprocating path;
a control board for controlling motor rotation.

2. The device as set forth in claim 1, wherein:
the diversion damper is coupled with the motor.

3. A method for diverting airflow, comprising:
dividing flow of air into desired paths; and
providing the divided flow of air to desired destinations.
